(19) United States
(12) Patent Application Publication
(10) Pub. No.: US 2026/0103241 A1
(43) Pub. Date: Apr. 16, 2026

(54) VEHICLE SIDE STRUCTURE

(71) Applicant: TOYOTA JIDOSHA KABUSHIKI KAISHA, Toyota-shi (JP)

(72) Inventor: Tomohiro SAKURAI, Seto-shi (JP)

(73) Assignee: TOYOTA JIDOSHA KABUSHIKI KAISHA, Toyota-shi (JP)

(21) Appl. No.: 19/227,860

(22) Filed: Jun. 4, 2025

(30) Foreign Application Priority Data
Oct. 11, 2024 (JP) 2024-179421

(51) Int. Cl. B62D 21/15; B62D 25/02; B62D 25/04; B62D 25/16; B62D 27/02; B62D 29/00

(52) U.S. Cl. CPC B62D 21/157; B62D 25/025; B62D 25/04; B62D 25/16; B62D 27/023; B62D 29/008

(57) ABSTRACT

The vehicle side structure includes a skeleton body which is a die cast product integrally having a wheel arch portion and an A-pillar inner provided on a rear side of the wheel arch portion, and a rocker provided on an outer side of the A-pillar inner in the vehicle width direction and joined to the A-pillar inner, wherein the A-pillar inner has a base portion and a convex portion protruding outward in the vehicle width direction from the base portion, and the rocker has a vertical wall portion joined to the base portion, and an upper flange portion and an upper web portion joined to the convex portion.

### CROSS-REFERENCE TO RELATED APPLICATION

This application claims priority to Japanese Patent Application No. 2024-179421 filed on Oct. 11, 2024. The disclosure of the above-identified application, including the specification, drawings, and claims, is incorporated by reference herein in its entirety.

### BACKGROUND

### 1. Technical Field

The present disclosure relates to a vehicle side structure.

2. Description of Related Art

Japanese Unexamined Patent Application Publication No. 2019-93819 (JP 2019-93819 A) discloses a vehicle front structure including a front pillar inner and a rocker inner provided on the inner side of the front pillar inner in the vehicle width direction and joined to the front pillar inner. In this structure, the front pillar inner is provided to extend in the up-down direction. The rocker inner includes an upper flange portion, a lower flange portion, and a bulging portion that bulges inward in the vehicle width direction between the upper flange portion and the lower flange portion.

### SUMMARY

In the structure described in JP 2019-93819 A, the rocker inner is provided on the inner side in the vehicle width direction with respect to the pillar inner. On the other hand, in some vehicles, the rocker inner is provided on the outer side in the vehicle width direction with respect to the pillar inner. In the structure described in JP 2019-93819 A, when the rocker inner is provided on the outer side in the vehicle width direction with respect to the pillar inner, the rocker inner abuts against the pillar inner only at a bulging portion. Therefore, a joint portion between the rocker inner and the pillar inner can be provided only at one place, where the bulging portion of the rocker inner and the pillar inner abut against each other. Thus, there are not many joint portions between the pillar inner and the rocker, and there is a possibility that the rigidity of the joint portion between the pillar inner and the rocker is low.

In view of the above, it is an object of the present disclosure to provide a vehicle side structure capable of improving the rigidity of a joint portion between a pillar portion and a rocker portion.

A first aspect provides a vehicle side structure including:
a skeleton body that is a die cast product integrally including a wheel arch portion and a pillar portion provided on a rear side of the wheel arch portion; and
a rocker portion provided on an outer side of the pillar portion in a vehicle width direction and joined to the pillar portion, in which:
the pillar portion includes a base portion and a convex portion that projects outward in the vehicle width direction from the base portion; and
the rocker portion includes a first joint portion joined to the base portion and a second joint portion joined to the convex portion.

In the vehicle side structure according to the first aspect, the pillar portion includes a base portion and a convex portion that protrudes outward in the vehicle width direction from the base portion. Consequently, it is possible to provide a joint point for joining the base portion of the pillar portion and the first joint portion of the rocker portion, and a joint point for joining the convex portion of the pillar portion and the second joint portion of the rocker portion, as joint portions for joining the pillar portion and the rocker portion. That is, a plurality of joint points between the pillar portion and the rocker portion can be provided. Thus, the rigidity of the joint portion between the pillar portion and the rocker portion can be improved as compared with the case where there is a single joint point between the rocker portion and the pillar portion.

A second aspect provides the vehicle side structure according to the first aspect, in which:
the convex portion includes a side wall portion that extends outward in the vehicle width direction from the base portion, and a top portion that extends upward in a vehicle up-down direction from an outer end portion of the side wall portion in the vehicle width direction;
the second joint portion includes a first wall portion that extends in the vehicle up-down direction, and a second wall portion that extends inward in the vehicle width direction from a lower end portion of the first wall portion;
the side wall portion and the second wall portion are joined to each other; and
the top portion and the first wall portion are joined to each other.

In the vehicle side structure according to the second aspect, the side wall portion of the convex portion and the second wall portion of the rocker portion are connected to each other, and the top portion of the convex portion and the first wall portion of the rocker portion are connected to each other. That is, there are two joint portions between the rocker portion and the convex portion. Consequently, the rigidity of the joint portion between the convex portion (in other words, the pillar portion including the convex portion) and the rocker portion can be further improved as compared with the case where there is a single joint point between the rocker portion and the convex portion. As a result, the rigidity of the entire vehicle side structure can be further improved.

A third aspect provides the vehicle side structure according to the second aspect, in which:
an energy absorbing portion is accommodated in the rocker portion; and
the energy absorbing portion is joined to the first wall portion.

In the vehicle side structure according to the third aspect, the energy absorbing portion is joined to the first wall portion of the rocker portion. Consequently, the first wall portion and the energy absorbing portion can be easily joined to each other when the first wall portion and the top portion are joined to each other. Thus, it is possible to simplify the work of joining the energy absorbing portion.

As described above, the vehicle side structure according to the present disclosure has an excellent effect that the rigidity of the joint portion between the pillar portion and the rocker portion can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of a vehicle side structure according to the present embodiment;

FIG. 2 is a sectional view taken along the arrow II-II of FIG. 1;

FIG. 3 is a diagrammatic representation of the displacement of the vehicle side structure of FIG. 1 at the respective positions in the longitudinal direction of the vehicle side structure when the vehicle side structure is loaded; and

FIG. 4 is a longitudinal sectional view of a vehicle side structure according to a comparative example.

### DETAILED DESCRIPTION OF EMBODIMENTS

Hereinafter, an embodiment of a vehicle side structure 10 according to the present disclosure will be described with reference to the drawings. Note that an arrow FR appropriately shown in the drawings indicates the front side of the vehicle in the vehicle front-rear direction, an arrow IN indicates the inside in the vehicle widthwise direction, and an arrow UP indicates the upper side of the vehicle in the vehicle up-down direction. In the following description, the terms “front-rear direction”, “width direction”, and “up-down direction” refer to the vehicle front-rear direction, the vehicle width direction, and the vehicle up-down direction, respectively. In addition, the left-right direction means a left-right direction in a state facing the front of the vehicle.

### Vehicle

The vehicle to which the vehicle side structure 10 according to the present embodiment is applied is, for example, a battery-type electrified vehicle (BEV: Battery Electric Vehicle). Note that the vehicle to which the vehicle side structure 10 according to the present embodiment can be applied is not limited to BEV. For example, the vehicle side structure 10 according to the present embodiment may be applied to a fuel cell electric vehicle or the like.

### Vehicle Side Structure

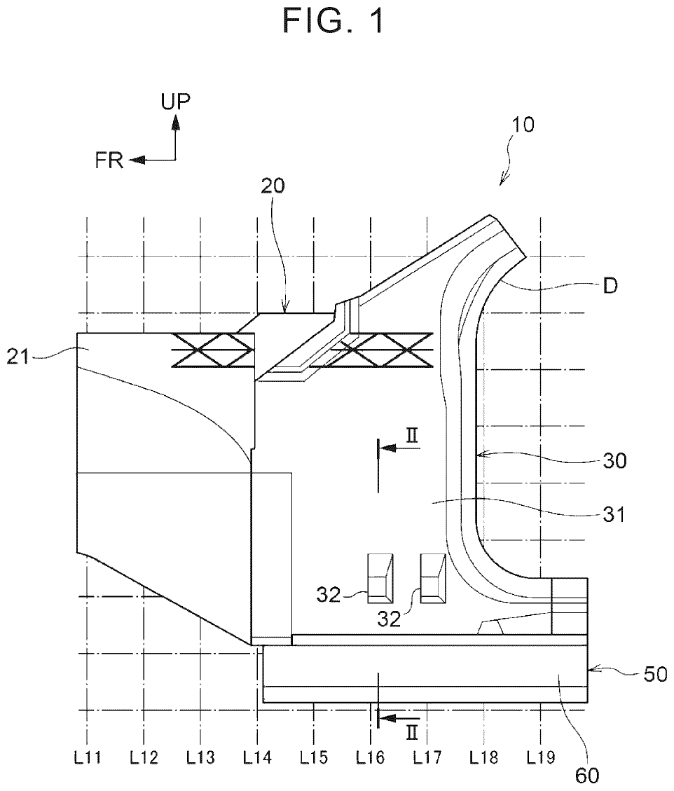

As shown in FIG. 1, the vehicle side structure 10 includes a skeleton body 20 that is a die cast product. The vehicle side structure 10 includes an A-pillar outer 40 provided on the outer side in the vehicle width direction of the skeleton body 20, and a rocker (rocker portion) 50 provided on the rear side in the vehicle front-rear direction of the skeleton body 20. FIG. 1 shows a state in which the vehicle side structure 10 is viewed from the inside in the vehicle width direction. That is, in FIG. 1, the rear side of the paper surface is the outer side in the vehicle width direction, and the front side of the paper surface is the inner side in the vehicle width direction.

As shown in FIG. 1, the skeleton body 20 integrally includes a pair of left and right wheel arch portions 21, a cross member (not shown), and a pair of left and right A-pillar inners (pillar portions) 30. The cross member connects the pair of left and right wheel arch portions 21. The pair of left and right A-pillar inners 30 is provided on the rear side of the wheel arch portion 21. The skeleton body 20 is formed by die casting using an aluminum alloy, a magnesium alloy, or the like as a material.

Each of the wheel arch portions 21 is configured to accommodate a front wheel (not shown). An A-pillar inner 30 and an A-pillar outer 40 are provided on the rear side of each wheel arch portion 21 in the vehicle front-rear direction.

### A-Pillar Inner

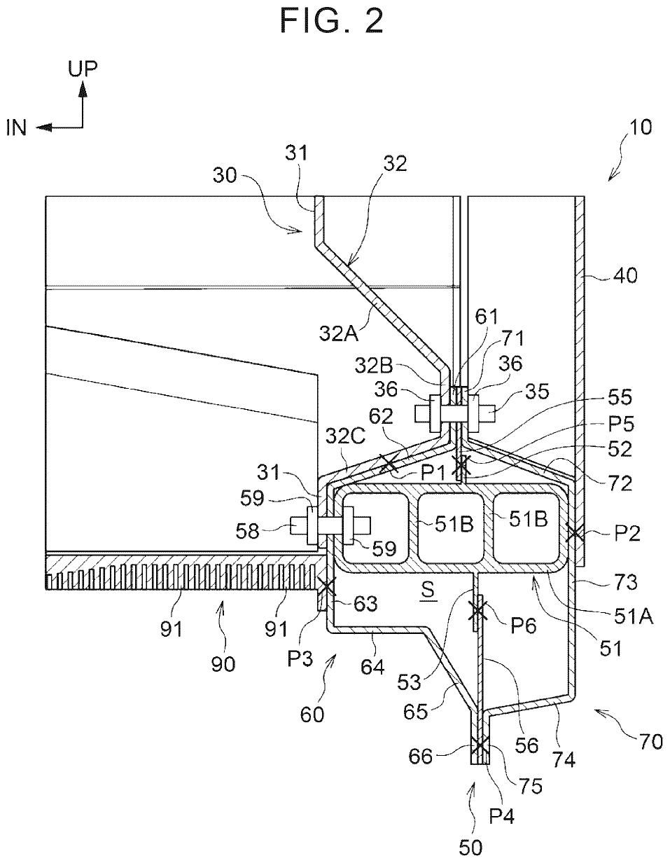

As shown in FIGS. 1 and 2, the A-pillar inner 30 is a plate-shaped member. The A-pillar inner 30 is arranged such that a plate surface (main surface) is a surface including a vehicle front-rear direction and a vehicle up-down direction. As shown in FIG. 2, the A-pillar inner 30 is provided inside the A-pillar outer 40 in the vehicle width direction. The A-pillar inner 30 and the A-pillar outer 40 are separated from each other, and the outer surface of the A-pillar inner 30 and the inner surface of the A-pillar outer 40 face each other. A space is provided between the A-pillar inner 30 and the A-pillar outer 40. The A-pillar inner 30 and the A-pillar outer 40 are joined at a joint point (not shown), and constitute an A-pillar.

As shown in FIG. 1, a door opening D is provided on the rear side of the A-pillar inner 30. The rear end portion of the A-pillar inner 30 defines a portion of the door opening D. As shown in FIG. 2, the A-pillar inner 30 integrally has a base portion 31 and a convex portion 32 protruding outward in the vehicle width direction from the base portion 31 in a cross section (hereinafter, referred to as a “vertical cross section”) cut in a plane orthogonal to the vehicle front-rear direction.

The base portion 31 is continuous with the wheel arch portion 21. The base portion 31 is a portion of the A-pillar inner 30 where the convex portion 32 is not provided. The base portion 31 is formed in a substantially flat plate shape, and is arranged such that a plate surface (main surface) is a surface including a vehicle front-rear direction and a vehicle up-down direction.

A plurality of convex portions 32 (two in the present embodiment as an example) are provided. The plurality of convex portions 32 are provided in the lower portion of the A-pillar inner 30, and are arranged side by side at predetermined intervals along the vehicle front-rear direction.

As shown in FIGS. 1 and 2, the convex portion 32 protrudes outward in the vehicle width direction. Note that, since FIG. 1 is a view of the A-pillar inner 30 from the inside in the vehicle width direction, the convex portion 32 illustrated in FIG. 1 protrudes in the depth direction of the drawing. As shown in FIG. 1, the convex portion 32 is formed in a truncated quadrangular pyramid shape. The side surface of the convex portion 32 is inclined so that the cross-sectional area decreases toward the tip (in other words, the outer end portion in the vehicle width direction).

As shown in FIG. 2, in a longitudinal section, the convex portion 32 integrally has an upper side wall portion 32A, a top portion 32B, and a lower side wall portion (side wall portion) 32C. The upper side wall portion 32A is bent from the base portion 31 and extends outward and downward in the vehicle-width direction. The top portion 32B is bent from the lower end of the upper side wall portion 32A and extends downward. The lower side wall portion (side wall portion) 32C is bent from the lower end of the top portion 32B and extends inward and downward in the vehicle-width direction.

The upper side wall portion 32A and the lower side wall portion 32C are provided to be inclined with respect to the base portion 31. The inclination angle of the upper side wall portion 32A is smaller than the inclination angle of the lower side wall portion 32C. Incidentally, the inclination angle of the upper side wall portion 32A and the lower side wall portion 32C is an acute angle of the angle with respect to the base portion 31.

The top portion 32B is bent from an outer end portion of the lower side wall portion 32C and extends upward. The top portion 32B extends substantially parallel to the base portion 31. The outer side surface of the top portion 32B in the vehicle width direction is in surface-contact with the inner side surface of the rocker 50 (specifically, the flange portion 61 of the rocker inner 60) in the vehicle width direction. Further, a through-hole penetrating in the vehicle-width direction (in other words, the plate-thickness direction) is formed in the top portion 32B, and a bolt 35 is inserted into the through-hole. The top portion 32B is fastened and fixed to the upper flange portion 61 of the rocker inner 60, the upper joint plate 55, and the upper flange portion 71 of the rocker outer 70, which will be described later, by a nut 36 screwed to both ends of the bolt 35 and the bolt 35.

The lower side wall portion 32C extends upward and outward in the vehicle-width direction from the base portion 31 (specifically, a part of the base portion 31 located on the lower side of the convex portion 32). The outer surface of the lower side wall portion 32C in the vehicle width direction is in surface-contact with the inner surface of the upper web portion 62 of the rocker inner 60 in the vehicle width direction. The lower side wall portion 32C and the upper web portions 62 of the rocker inner 60 are joined by self-piercing rivets at a joint point P1.

### A-Pillar Outer

The A-pillar outer 40 is a plate-shaped member. The A-pillar outer 40 is formed of, for example, a steel plate. The A-pillar outer 40 is arranged such that a plate surface (main surface) is a surface including a vehicle front-rear direction and a vehicle up-down direction. As shown in FIG. 2, the A-pillar outer 40 is provided outside the A-pillar inner 30 in the vehicle width direction. The inner surface of the lower end of the A-pillar outer 40 is in surface contact with the outer surface of the rocker 50 (specifically, the rocker outer 70). The A-pillar outer 40 and the rocker outer 70 are joined to each other by spot-welding at a joint point P2.

### Rocker

The rocker 50 is an elongated member extending in the vehicle front-rear direction, and a space (hereinafter, referred to as an “internal space S”) is provided therein. The rocker 50 accommodates the energy absorbing portion 51 in the internal space S. The rocker 50 is joined to the A-pillar inner 30 and the A-pillar outer 40. The rocker 50 is provided on the outer side of the A-pillar inner 30 in the vehicle width direction. The rocker 50 is provided inside the A-pillar outer 40 in the vehicle width direction. That is, the rocker 50 is provided between the A-pillar inner 30 and the A-pillar outer 40.

The rocker 50 includes a rocker inner 60 joined to the A-pillar inner 30, and a rocker outer 70 provided on the outer side of the rocker inner 60 in the vehicle width direction and joined to the A-pillar outer 40. The rocker inner 60 and the rocker outer 70 are arranged so as to face each other, and an internal space S is provided between the rocker inner 60 and the rocker outer 70. The rocker inner 60 and the rocker outer 70 are joined by a joint (not shown).

The rocker inner 60 is a plate-shaped member. The rocker inner 60 is formed of, for example, a steel plate. The rocker inner 60 has a substantially hat-shaped longitudinal section. The rocker inner 60 has a uniform longitudinal cross-sectional shape over the entire area in the vehicle front-rear direction. The rocker inner 60 integrally has, in a longitudinal section, an upper flange portion 61, an upper web portion 62, a vertical wall portion 63, a first lower web portion 64, a second lower web portion 65, and a lower flange portion 66. The upper flange portion 61 is in surface-contact with the top portion 32B of the convex portion 32. The upper flange portion 61 is an example of the first wall portion of the second joint portion. The upper web portion 62 is bent from the lower end portion of the upper flange portion 61 and extends downward and inward in the vehicle width direction. The upper web portion 62 is an example of a second wall portion of the second joint portion. The vertical wall portion 63 is bent from the lower end portion of the upper web portion 62 and extends downward. The vertical wall portion 63 is an example of a first joint portion. The first lower web portion 64 is bent from the lower end of the vertical wall portion 63 and extends outward in the vehicle width direction. The second lower web portion 65 is bent from an outer end portion of the first lower web portion 64 in the vehicle width direction and extends downward and outward in the vehicle width direction. The lower flange portion 66 is bent from the lower end of the second lower web portion 65 and extends downward. The upper flange portion 61, the upper web portion 62, and the vertical wall portion 63 of the rocker inner 60 are shaped according to the upper side wall portion 32A, the top portion 32B, and the base portion 31 of the convex portion 32 of the A-pillar inner 30.

The upper flange portion 61 extends substantially parallel to the top portion 32B. A substantially entire area of the inner side surface of the upper flange portion 61 in the vehicle width direction is in surface-contact with the outer side surface of the top portion 32B in the vehicle width direction. Further, substantially the entire area of the outer surface of the upper flange portion 61 in the vehicle width direction is in surface contact with the inner surface of the upper joint plate 55 in the vehicle width direction. Further, the upper flange portion 61 is formed with a through-hole that penetrates in the vehicle width direction (in other words, the plate thickness direction), and a bolt 35 is inserted into the through-hole. The upper flange portion 61 is fastened and fixed to the top portion 32B of the convex portion 32, the upper joint plate 55, and the upper flange portion 71 of the rocker outer 70 to be described later by a nut 36 screwed to both ends of the bolt 35 and the bolt 35.

The upper web portions 62 extend substantially parallel to the lower side wall portion 32C. The substantially entire area of the inner side surface of the upper web portion 62 in the vehicle width direction (in other words, the upper side surface in the vehicle up-down direction) is in surface-contact with the outer side surface of the lower side wall portion 32C in the vehicle width direction (in other words, the lower side surface in the vehicle up-down direction). The upper web portion 62 and the lower side wall portion 32C are joined to each other by self-piercing rivets at the joint point P1. The outer side surface of the upper web portion 62 in the vehicle width direction (in other words, the lower side surface in the vehicle up-down direction) faces the internal space S.

The vertical wall portion 63 extends substantially in parallel with the base portion 31. An upper portion of an inner surface of the vertical wall portion 63 in the vehicle width direction is in surface contact with an outer surface of the base portion 31 (specifically, a portion of the base portion 31 located on the lower side of the convex portion 32) in the vehicle width direction. The lower portion of the inner surface of the vertical wall portion 63 in the vehicle width direction is in surface contact with the outer end portion of the heat radiation fin portion 90 in the vehicle width direction. An upper portion of an outer surface of the vertical wall portion 63 in the vehicle width direction is in surface contact with an energy absorbing portion 51 described later. The vertical wall portion 63 and the heat radiation fin portion 90 are joined by spot-welding at a joint point P3. The lower portion of the outer side surface of the vertical wall portion 63 in the vehicle width direction faces the internal space S. Further, the vertical wall portion 63 is formed with a through-hole that penetrates in the vehicle width direction (in other words, the plate thickness direction), and a bolt 58 is inserted into the through-hole. The vertical wall portion 63 is fastened and fixed to the base portion 31 and the energy absorbing portion 51 by a nut 59 screwed to both ends of the bolt 58 and the bolt 58.

The upper surface of the first lower web portion 64 in the vehicle up-down direction faces the internal space S. In the second lower web portion 65, the outer side surface in the vehicle width direction (in other words, the upper side surface in the vehicle up-down direction) faces the internal space S.

The substantially entire area of the outer surface of the lower flange portion 66 in the vehicle width direction is in surface contact with the inner surface of the lower joint plate 56 in the vehicle width direction. The lower flange portion 66 is spot-welded to the lower joint plate 56 and the lower flange portion 75 of the rocker outer 70 at the joint point P4.

The rocker outer 70 is a plate-shaped member. The rocker outer 70 is made of, for example, steel. The rocker outer 70 has a substantially hat-shaped longitudinal section. The rocker outer 70 has a uniform longitudinal cross-sectional shape over the entire area in the vehicle front-rear direction. The rocker outer 70 integrally has, in a longitudinal section, an upper flange portion 71, an upper web portion 72, a vertical wall portion 73, a lower web portion 74, and a lower flange portion 75. The upper flange portion 71 is in surface contact with the upper flange portion 61 of the rocker inner 60 via the upper joint plate 55. The upper web portion 72 is bent from the lower end portion of the upper flange portion 71 and extends downward and outward in the vehicle width direction. The vertical wall portion 73 is bent from the lower end portion of the upper web portion 72 and extends downward. The lower web portion 74 is bent from the lower end of the vertical wall portion 73 and extends downward and inward in the vehicle width direction. The lower flange portion 75 is bent from the lower end portion of the lower web portion 74 and extends downward.

The upper flange portion 71 extends substantially parallel to the top portion 32B and the upper flange portion 61 of the rocker inner 60. The substantially entire area of the inner side surface of the upper flange portion 71 in the vehicle width direction is in surface contact with the outer side surface of the upper joint plate 55 in the vehicle width direction. Further, the upper flange portion 71 is formed with a through-hole that penetrates in the vehicle width direction (in other words, the plate thickness direction), and a bolt 35 is inserted into the through-hole. The upper flange portion 71 is fastened and fixed to the top portion 32B of the convex portion 32, the upper joint plate 55, and the upper flange portion 61 of the rocker inner 60 by a nut 36 screwed to both ends of the bolt 35 and the bolt 35.

In the upper web portion 72, an inner side surface in the vehicle width direction (in other words, a lower side surface in the vehicle up-down direction) faces the internal space S. In the lower web portion 74, an inner side surface in the vehicle width direction (in other words, an upper side surface in the vehicle up-down direction) faces the internal space S.

The vertical wall portion 73 extends substantially parallel to the base portion 31 and the vertical wall portion 63 of the rocker inner 60. An upper portion of an inner side surface of the vertical wall portion 73 in the vehicle width direction is in contact with the energy absorbing portion 51. The lower portion of the inner surface of the vertical wall portion 73 in the vehicle width direction faces the internal space S. An upper portion of an inner surface of the vertical wall portion 73 in the vehicle width direction is in surface contact with a lower portion of an inner surface of the rocker outer 70 in the vehicle width direction. The vertical wall portion 73 and the rocker outer 70 are joined to each other by spot-welding at a joint point P2.

The substantially entire area of the inner side surface of the lower flange portion 75 in the vehicle width direction is in surface contact with the outer side surface of the lower joint plate 56 in the vehicle width direction. The lower flange portion 75 is spot-welded to the lower joint plate 56 and the lower flange portion 66 of the rocker inner 60 at the joint point P4.

An energy absorbing portion 51 is provided in the internal space S of the rocker 50. The energy absorbing portion 51 includes a housing 51A that forms an outer shell having a substantially rectangular parallelepiped shape, and a plurality of vertical wall portions 51B that are provided inside the housing 51A and connect the top portion and the bottom portion of the housing 51A. The plurality of vertical wall portions 51B are arranged at predetermined intervals along the vehicle-width direction. The energy absorbing portion 51 is configured in a ladder shape in a longitudinal section. The energy absorbing portion 51 absorbs collision energy by deforming when a colliding object collides with a side portion of the vehicle.

An inner end portion of the energy absorbing portion 51 in the vehicle width direction is in contact with an outer surface of the rocker inner 60 (specifically, the vertical wall portion 63 of the rocker inner 60). A through-hole penetrating in the vehicle width direction (in other words, the plate thickness direction) is formed at an inner end portion of the energy absorbing portion 51 in the vehicle width direction, and a bolt 58 is inserted into the through-hole. The energy absorbing portion 51 is fastened and fixed to the vertical wall portion 63 of the rocker inner 60 and the base portion 31 of the A-pillar inner 30 by a nut 59 screwed to both ends of the bolt 58 and the bolt 58. Further, the outer end portion of the energy absorbing portion 51 in the vehicle width direction is in contact with the inner surface of the vertical wall portion 73 of the rocker outer 70 in the vehicle width direction.

An upper joint portion 52 is connected to an upper surface of the energy absorbing portion 51. The upper joint portion 52 is a plate-shaped member and extends upward from the upper surface of the energy absorbing portion 51. The inner side surface of the upper joint portion 52 in the vehicle width direction is in surface contact with the outer side surface of the upper joint plate 55. The inner surface of the upper joint portion 52 and the outer surface of the upper joint plate 55 are joined by self-piercing rivets at the joint point P5.

The upper joint plate 55 is a plate-like member and is provided so as to be sandwiched between the upper flange portion 61 of the rocker inner 60 and the upper flange portion 71 of the rocker outer 70. The upper joint plate 55 is formed with a through-hole that penetrates in the vehicle width direction (in other words, in the plate thickness direction), and a bolt 35 is inserted into the through-hole. The upper joint plate 55 is fastened and fixed to the top portion 32B of the convex portion 32, the upper flange portion 61 of the rocker inner 60, and the upper flange portion 71 of the rocker outer 70 by a nut 36 screwed to both ends of the bolt 35 and the bolt 35.

A lower joint portion 53 is connected to a lower surface of the energy absorbing portion 51. The lower joint portion 53 is a plate-shaped member and extends downward from the lower surface of the energy absorbing portion 51. The outer side surface of the lower joint portion 53 in the vehicle width direction is in surface contact with the inner side surface of the lower joint plate 56. The inner surface of the lower joint portion 53 and the outer surface of the lower joint plate 56 are joined by self-piercing rivets at the joint point P6.

The lower joint plate 56 is a plate-like member and is provided so as to be sandwiched between the lower flange portion 66 of the rocker inner 60 and the lower flange portion 75 of the rocker outer 70. The lower joint plate 56 is spot-welded to the lower flange portion 66 of the rocker inner 60 and the lower flange portion 75 of the rocker outer 70 at the joint point P4.

Further, a heat radiation fin portion 90 having a plurality of fins 91 is joined to an inner surface of the rocker 50 (specifically, the vertical wall portion 63 of the rocker inner 60). The heat radiation fin portion 90 has a plurality of fins 91 extending in the vehicle front-rear direction. The plurality of fins 91 are arranged at predetermined intervals along the vehicle width direction.

### Action and Effect

According to the present embodiment, the following effects can be obtained. In the present embodiment, the skeleton body 20 is a die-cast product. Therefore, the skeleton body 20 itself has high rigidity. However, if the rigidity of the joint portion between the skeleton body 20 and the rocker 50 is low, the joint portion between the skeleton body 20 and the rocker 50 may become an inflection point, and the rigidity of the entire vehicle side structure 10 may be reduced.

On the other hand, in the present embodiment, the A-pillar inner 30 has a base portion 31 and a convex portion 32 protruding outward in the vehicle width direction from the base portion 31. As a result, as a joint portion for joining the A-pillar inner 30 and the rocker 50, a joint portion for joining the base portion 31 of the A-pillar inner 30 and the rocker 50 (specifically, the vertical wall portion 63) can be provided. Further, as a joint portion for joining the A-pillar inner 30 and the rocker 50, a joint portion for joining the convex portion 32 of the A-pillar inner 30 and the rocker 50 (specifically, the upper flange portion 61 and the upper web portion 62) can be provided. That is, a plurality of joints between the A-pillar inner 30 and the rocker 50 can be provided. Therefore, the rigidity of the joint portion between the A-pillar inner 30 and the rocker 50 can be improved as compared with the case where the joint portion between the rocker 50 and the A-pillar inner 30 is a single joint. As a result, the rigidity of the entire vehicle side structure 10 can be improved.

Further, in the present embodiment, the lower side wall portion 32C of the convex portion 32 and the upper web portion 62 of the rocker 50 are joined to each other, and the top portion 32B of the convex portion 32 and the upper flange portion 61 of the rocker 50 are joined to each other. That is, there are two joints between the rocker 50 and the convex portion 32. As a result, the rigidity of the joint portion between the convex portion 32 (in other words, the A-pillar inner 30 including the convex portion 32) and the rocker 50 can be further improved as compared with the case where the joint point between the rocker 50 and the convex portion 32 is a single joint point. As a result, the overall rigidity of the vehicle side structure 10 can be further improved.

Further, in the present embodiment, since not only the joint portion between the rocker 50 and the convex portion 32 but also the rocker 50 and the base portion 31 are joined, the joint portion between the A-pillar inner 30 and the rocker 50 is three positions. Therefore, the rigidity of the joint portion between the A-pillar inner 30 and the rocker 50 can be further improved. As a result, the overall rigidity of the vehicle side structure 10 can be further improved.

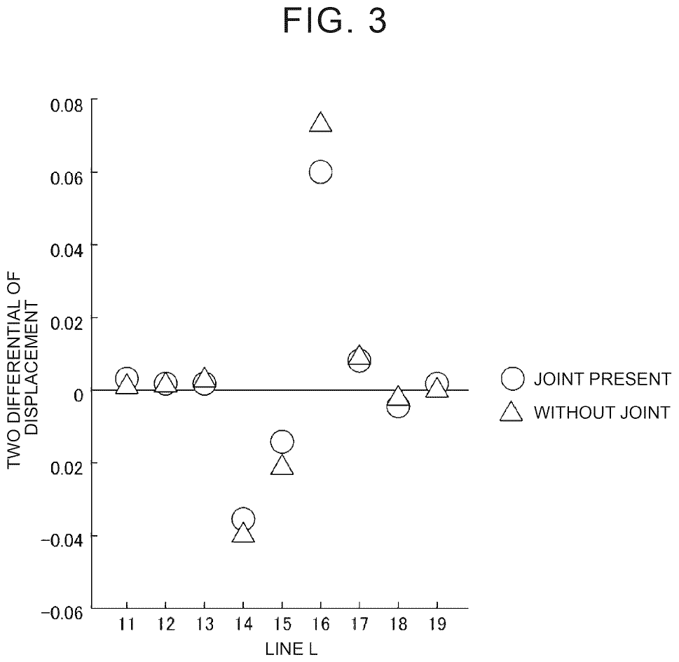

The rigidity improvement effect of the present embodiment will be described in detail with reference to FIG. 3. In FIG. 3, the horizontal axis represents the position of the vehicle side structure 10 in the vehicle front-rear direction indicated by a dashed line in FIG. 1. In addition, the vertical axis represents a displacement amount (specifically, a numerical value obtained by performing two times differentiation with respect to the displacement amount) when a load is applied to a part of the vehicle (for example, a fastening portion of the suspension upper arm portion). In addition, a case where the convex portion 32 and the rocker 50 are joined as in the present embodiment is referred to as “joined”, and a case where the convex portion 32 and the rocker 50 are not joined is referred to as “not joined”.

As shown in FIG. 3, a L14, L15, L16 in which a large displacement occurs is considered to be an inflection point of the vehicle side structure 10, but it can be seen that at this inflection point, the displacement is smaller in the case of “joined”. Therefore, also from FIG. 3, it can be understood that the rigidity of the joint portion between the A-pillar inner 30 and the rocker 50 is improved in the present embodiment.

In general, the A-pillar inner 30 is manufactured by sheet-metal working of a high-tension material. Since the high-tensile material has high strength, workability is poor, and it is difficult to have a complicated shape in sheet metal processing. Therefore, it is difficult to form the convex portion 32, which is a relatively deep drawing that can be joined to the rocker 50, in the A-pillar inner 30 by sheet metal processing. On the other hand, in the vehicle side structure 10 according to the present embodiment, since the A-pillar inner 30 is a die-cast product, the shape of the A-pillar inner 30 is easily formed into a desired shape. Thus, the convex portion 32 that can be joined to the rocker 50 can be easily formed in the A-pillar inner 30.

Further, in the present embodiment, the energy absorbing portion 51 is joined to the upper flange portion 61 of the rocker 50 via the upper joint plate 55. Accordingly, the energy absorbing portion 51 can be joined to the rocker 50 at the time of joining the upper flange portion 61 and the top portion 32B. Therefore, the joining operation of the energy absorbing portion 51 can be simplified.

Further, in the present embodiment, the convex portion 32 of the A-pillar inner 30 is provided so as to contact the contact portion between the upper flange portion 61 of the rocker inner 60 and the upper flange portion 71 of the rocker outer 70. As a result, the joining device can access the contact portion between the upper flange portion 61 of the rocker inner 60 and the upper flange portion 71 of the rocker outer 70 via the convex portion 32. Accordingly, the upper flange portion 61 of the rocker inner 60 and the upper flange portion 71 of the rocker outer 70 can be joined to each other. Therefore, the rigidity of the rocker 50 can be improved. By improving the rigidity of the rocker 50, it is possible to improve the rigidity of the entire vehicle side structure 10.

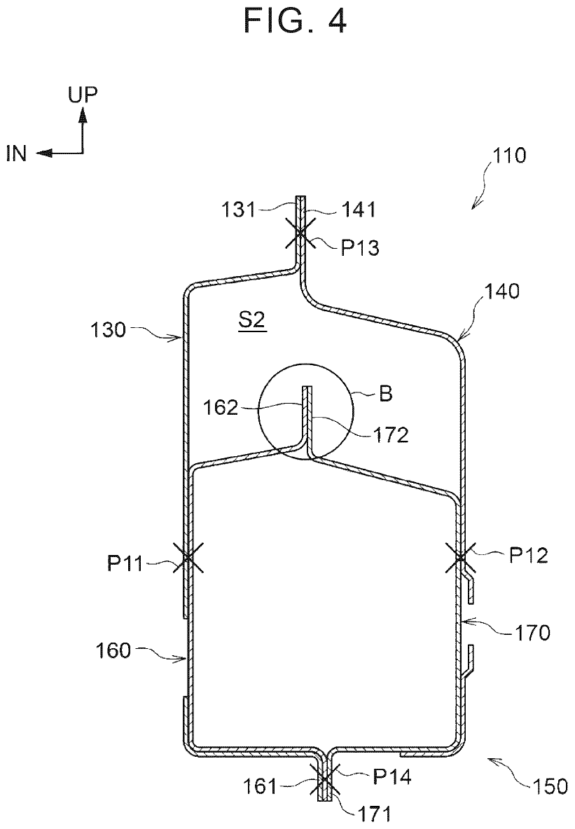

The effect of improving the rigidity of the rocker 50 in the present embodiment will be described in detail with reference to the vehicle side structure 110 according to the comparative example shown in FIG. 4. In FIG. 4, a longitudinal section of the vehicle side structure 110 is shown.

The vehicle side structure 110 according to the comparative example includes an A-pillar inner 130, an A-pillar outer 140, a rocker inner 160, and a rocker outer 170.

The lower portion of the A-pillar inner 130 and the rocker inner 160 are joined at a joint point P11. In addition, the lower portion of the A-pillar outer 140 and the rocker outer 170 are joined to each other at a joint point P12. The flange portion 131 provided at the upper portion of the A-pillar inner 130 and the flange portion 141 provided at the upper portion of the A-pillar outer 140 are joined at a joint point P13. In addition, the lower flange portion 161 provided at the lower portion of the rocker inner 160 and the lower flange portion 171 provided at the lower portion of the rocker outer 170 are joined at a joint point P14.

When the vehicle side structure 110 is manufactured, it is manufactured in the following order. First, the A-pillar inner 130 and the rocker inner 160 are joined to each other (see the joint point P11). Next, the A-pillar outer 140 and the rocker outer 170 are joined to each other (see the joint point P12). Next, the flange portion 131 of the A-pillar inner 130 and the flange portion 141 of the A-pillar outer 140 are joined to each other (see the joint point P13). Next, the lower flange portion 161 of the rocker inner 160 and the lower flange portion 171 of the rocker outer 170 are joined to each other (see the joint point P14). Although there is no particular limitation on the joining method at each joint point, spot welding is an example of the joining method.

When the joint points are joined in this order, a closed space S2 is provided between the A-pillar inner 130 and the A-pillar outer 140, and the rocker inner 160 and the rocker outer 170. The upper flange portion 162 provided on the upper portion of the rocker inner 160 and the upper flange portion 172 provided on the upper portion of the rocker outer 170 (see B in FIG. 4) are provided in the closed space S2. Therefore, the joining device cannot be brought to the contact portion. Therefore, in the vehicle side structure 110 according to the comparative example, the upper flange portion 162 of the rocker inner 160 cannot be joined to the upper flange portion 172 of the rocker outer 170. Therefore, the rigidity of the rocker 150 may be low, and the rigidity of the entire vehicle side structure 110 may be low.

On the other hand, as shown in FIG. 2, in the vehicle side structure 10 according to the present embodiment, the convex portion 32 is provided in the A-pillar inner 30. Therefore, the joining device can be brought to the contact portion between the upper flange portion 61 of the rocker inner 60 and the upper flange portion 71 of the rocker outer 70 via the convex portion 32. Therefore, since the upper flange portion 61 of the rocker inner 60 and the upper flange portion 71 of the rocker outer 70 can be joined to each other, the rigidity of the rocker 50 can be increased and the rigidity of the entire vehicle side structure 10 can be improved.

### Modifications

Although the vehicle side structure according to the embodiment has been described above, the present disclosure can be appropriately modified in design without departing from the gist thereof. For example, in the above-described embodiment, an example in which the number of the convex portions 32 is two has been described, but the present disclosure is not limited thereto. The number of the convex portions 32 may be singular or three or more. Further, the shape of the convex portion 32 is not limited to the shape described in the above embodiment.

What is claimed is:

1. A vehicle side structure comprising:
a skeleton body that is a die cast product integrally including a wheel arch portion and a pillar portion provided on a rear side of the wheel arch portion; and
a rocker portion provided on an outer side of the pillar portion in a vehicle width direction and joined to the pillar portion, wherein:
the pillar portion includes a base portion and a convex portion that projects outward in the vehicle width direction from the base portion; and
the rocker portion includes a first joint portion joined to the base portion and a second joint portion joined to the convex portion.

2. The vehicle side structure according to claim 1, wherein:
the convex portion includes a side wall portion that extends outward in the vehicle width direction from the base portion, and a top portion that extends upward in a vehicle up-down direction from an outer end portion of the side wall portion in the vehicle width direction;
the second joint portion includes a first wall portion that extends in the vehicle up-down direction, and a second wall portion that extends inward in the vehicle width direction from a lower end portion of the first wall portion;
the side wall portion and the second wall portion are joined to each other; and
the top portion and the first wall portion are joined to each other.

3. The vehicle side structure according to claim 2, wherein:
an energy absorbing portion is accommodated in the rocker portion; and
the energy absorbing portion is joined to the first wall portion.
